(19) United States
(12) Patent Application Publication
(10) Pub. No.: US 2001/0018635 A1
(43) Pub. Date: Aug. 30, 2001

(54) Radio data communication apparatus

(75) Inventors: Toshiki Miyasaka, Urawa-shi (JP); Kazunori Aoyagi, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 09/793,521

(22) Filed: Feb. 27, 2001

(30) Foreign Application Priority Data
Feb. 28, 2000 (JP) 2000-052354

(51) Int. Cl. H04B 7/00; G09G 3/20

(52) U.S. Cl. 701/200; 455/412

(57) ABSTRACT

A radio data communication apparatus arranged in an electronic device to perform radio data communication with a contents stand uses authentication information read by the membership card information reader of the electronic device, and automatically executes authentication processing with the contents stand so as not to force the operator to perform cumbersome manipulation. After authentication processing ends, the radio data communication apparatus executes radio data communication with the contents stand. A membership card corresponds to the services of the contents stand, and authentication information is recorded in advance on the membership card.

### CROSS-REFERENCE TO RELATED APPLICATIONS

This application is based upon and claims the benefit of priority from the prior Japanese Patent Application No. 2000-052354, filed Feb. 28, 2000, the entire contents of which are incorporated herein by reference.

### BACKGROUND OF THE INVENTION

The present invention relates to a radio data communication apparatus for communicating data between electronic devices using a short-distance radio communication function such as Bluetooth.

In recent years, car electronics devices have remarkably spread. In addition to conventional car stereos and air conditioners, many information devices represented by a car navigation device, in-car television, and VICS (Vehicle Information and Communication System) are adopted.

Recently, demands arise for radio data communication apparatuses capable of easily acquiring external information in a vehicle from “contents stand” which provides pay or free contents such as music, sightseeing information, or the like.

An example of an apparatus for acquiring information from the contents stand is a registered terminal identification apparatus disclosed in Jpn. Pat. Appln. KOKAI Publication No. 11-53313.

Jpn. Pat. Appln. KOKAI Publication No. 11-53313 discloses a registered terminal identification apparatus for acquiring information in an information management center through a portable telephone connected to a car navigation device. In acquiring information, the user must input a user ID or password for authentication, and the manipulation is cumbersome.

In particular, the car safety is important in an electronic device manipulated by the driver of an automobile, and a general electronic device starts or ends its operation by only one manipulation as a rule. As for radio connection with the contents stand, many buttons do not interlock with other independent devices, and are not designed in consideration of the user's safety.

### BRIEF SUMMARY OF THE INVENTION

The present invention has been made in consideration of the above situation, and has as its object to provide an apparatus and method which can simplify manipulation concerning authentication procedures in radio communication between electronic devices, and allow safety driving even in access to an external contents stand from inside a vehicle.

According to one aspect of the present invention, there is provided a radio data communication apparatus configured to perform radio data communication with a contents stand which provides a service of contents, the radio data communication apparatus comprising: a membership card information reader configured to read authentication information recorded in advance from a membership card which is to be used for an authentication between the radio data communication apparatus and the contents stand; authentication means for executing authentication processing with the contents stand by use of the authentication information; means for making the authentication means to start an execution of the authentication processing by supplying the authentication information read by the membership card information reader to the authentication means; and data communication means for executing radio data communication with the contents stand after authentication processing by the authentication means ends.

According to another aspect of the present invention, there is provided a vehicle comprising: a car navigation device which receives car navigation information from outside and provides the information on a display; a radio data communication apparatus, connected to the car navigation device, configured to perform radio data communication with a contents stand which provides a service of contents, the radio data communication apparatus comprising: a membership card information reader configured to read authentication information recorded in advance from a membership card which is to be used for an authentication between the radio data communication apparatus and the contents stand; authentication means for executing authentication processing with the contents stand by use of the authentication information; means for making the authentication means to start an execution of the authentication processing by supplying the authentication information read by the membership card information reader to the authentication means; data communication means for executing radio data communication with the contents stand after authentication processing by the authentication means ends; and display control means for controlling the display so as to display the car navigation information and image information contained in the contents served from the contents stand.

According to still another aspect of the present invention, there is provided a radio communication method of communicating with a contents stand which provides a service of contents, the method comprising the steps of: awaiting an insertion of a membership card into a card reader, the membership card containing an authentication information which is recorded in advance; reading the authentication information from the membership card by the reader; invoking an opponent of a radio communication provided in the contents stand; sending the read authentication information to the opponent via the radio communication; receiving a confirmation of connection based on the authentication information from the opponent; and starting an authenticated radio communication using the confirmation of connection, the communication including a reception of the contents served from the contents stand.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the system configuration of an overall radio data communication apparatus according to an embodiment of the present invention;

FIG. 2 is a table showing the relationship between the transmission power and the transmissible distance when Bluetooth is used as a radio communication device;

FIG. 3 is a graph showing the relationship between the transmission power and the transmissible distance in FIG. 2;

FIG. 4 is a block diagram showing details of a car navigation device and radio communication apparatus in FIG. 1;

FIG. 5 is a flow chart showing processing operation on the car navigation device side; and

FIG. 6 is a flow chart showing processing operation on the contents stand side.

### DETAILED DESCRIPTION OF THE INVENTION

An embodiment of the present invention will be described below with reference to the several views of the accompanying drawing.

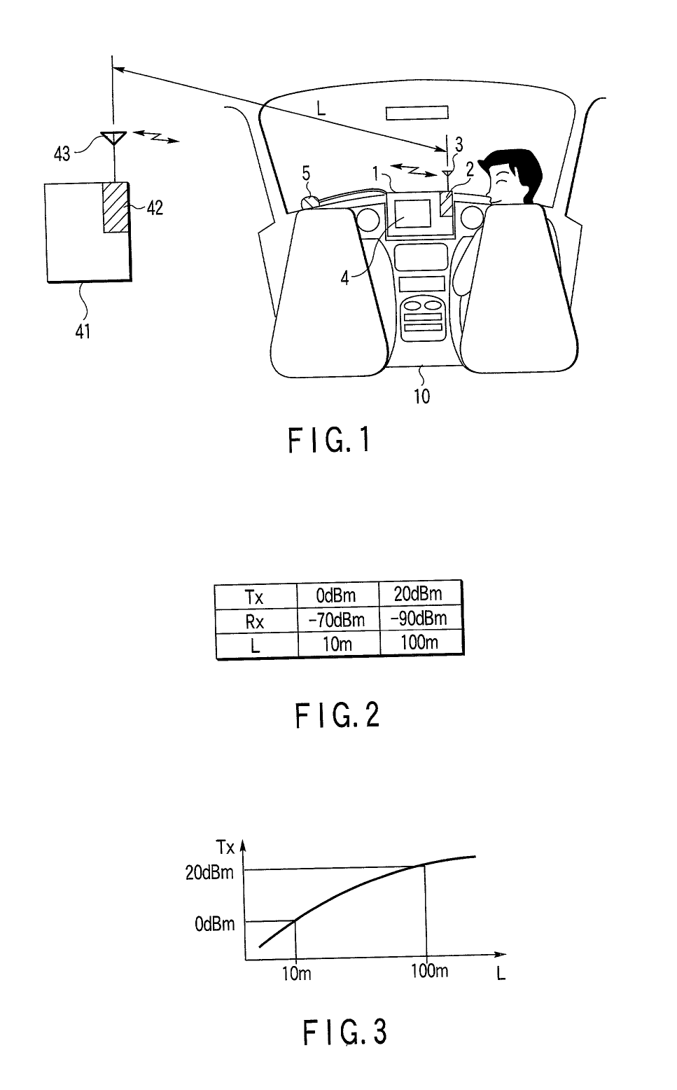

FIG. 1 is a view showing the system configuration of an overall radio data communication apparatus when the present invention is applied to a car navigation device. In FIG. 1, reference numeral 1 denotes a car navigation device mounted in a vehicle 10; 2, a radio communication apparatus using, e.g., Bluetooth assembled in the car navigation device 1; 3, a Bluetooth antenna for transmitting/receiving data between the car navigation device 1 and an external device; 4, an image display of the car navigation device 1; 5, a GPS signal reception antenna; and 6, a card slot of a membership card information reader arranged in the car navigation device 1.

Note that “Bluetooth” is a short-distance radio communication standard, and realizes radio communication within 10 m or 100 m using a 2.4-GHz ISM (Industrial Science Medical) band. Bluetooth employs a frequency hopping scheme as a spread spectrum technique, and enables connecting up to eight devices by a time division multiplex scheme.

In FIG. 1, reference numeral 41 denotes a contents stand (server) set outside the vehicle 10; 42, a radio unit using, e.g., Bluetooth assembled in the contents stand 41; and 43, an antenna which externally transmits data from the contents stand 41 and receives data from the car navigation device 1. Reference symbol L denotes a distance by which the car navigation device 1 and contents stand 41 can stably communicate with each other.

The contents stand 41 issues a membership card 31 made from a storage medium, e.g., an IC card to a user permitted for radio communication using the car navigation device 1. The membership card 31 is not limited to the IC card, and may be a resinous or paper card on which a magnetic recording portion is pasted.

This membership card 31 is a card which allows the user to utilize the services of the contents stand 41, the membership card of a convenience store, gas station, or the like, a bank card, the membership card of a restaurant, or the like.

The membership card 31 is recorded in advance with a PIN (Personal Identification Number) corresponding to the services of the contents stand 41. The PIN code is made up of 1 to 16 bytes or more. The contents stand 41 records in advance authentication information, e.g., PIN code on the issued membership card 31.

In radio communication with the contents stand 41, the user of the contents stand 41 inserts the membership card 31 into the card slot 6 of the car navigation device 1. The recorded information of the membership card 31 inserted through the card slot 6 is read by the membership card information reader, and used for authentication processing between the car navigation device 1 and the contents stand 41.

FIGS. 2 and 3 show a transmission power Tx, a reception sensitivity Rx, and the communicable distance L when Bluetooth is used as a radio communication means. For a transmission power of 0 dBm and a reception sensitivity of −70 dBm, the radio data communicable distance L is 10 m. For a transmission power of 20 dBm and a reception sensitivity of −90 dBm, the radio data communicable distance L is increased to 100 m. FIG. 3 is a graph showing this state by plotting the data communicable distance L along the abscissa and the transmission power Tx along the ordinate.

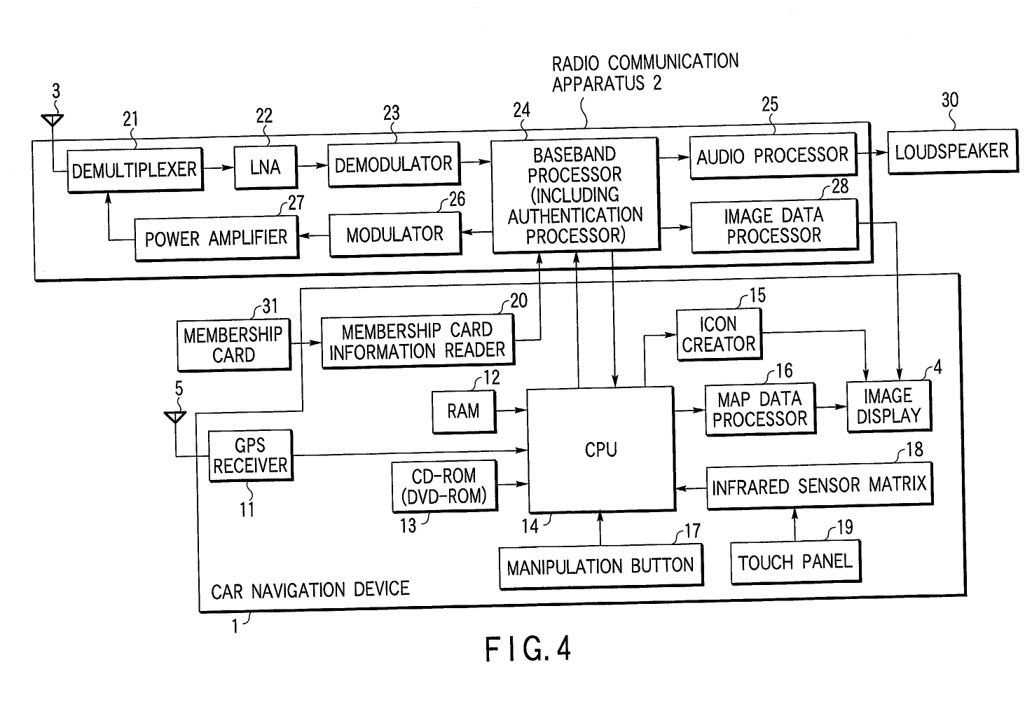

FIG. 4 is a block diagram showing the main parts of the car navigation device 1 and radio communication apparatus 2. The car navigation device 1 comprises a GPS receiver 11 for receiving GPS radio waves via the antenna 5, a RAM 12, a CD-ROM (or DVD-ROM) 13, a CPU 14, an icon creator 15, a map data processor 16, the image display 4, a manipulation button 17, an infrared sensor matrix 18, a touch panel 19, and a membership card information reader 20 for reading recorded information of the membership card 31.

The GPS receiver 11 operates under the control of the CPU 14. The GPS receiver 11 determines the current position of the vehicle 10 on the basis of GPS radio waves received by the GPS antenna 5, and inputs the current position to the CPU 14.

The RAM 12 is a memory device readable/writable by the CPU 14, and is used as a work area for temporarily storing various data.

The CD-ROM 13 stores car navigation map data in advance, and its recorded information is read out by the CPU 14.

The CPU 14 controls the whole car navigation device 1 and radio communication apparatus 2 in accordance with internal programs. For example, the CPU 14 reads out map data from the CD-ROM 13 on the basis of the current position of the vehicle 10 determined by the GPS receiver 11, and displays the map data on the image display 4 via the map data processor 16, thereby realizing a car navigation function.

The icon creator 15 creates a data communication start/end icon corresponding to the services of the contents stand 41 in accordance with an instruction from the CPU 14, and displays the created icon on the image display 4. The operation of the icon displayed on the image display 4 is set such that when the user first pushes the icon, data communication starts, and when the user pushes it again, communication ends.

The map data processor 16 processes map data read out from the CD-ROM 13 via the CPU 14, and displays the processed data on the image display 4.

The manipulation button 17 enables basic operation such as enlargement/reduction of the car navigation map and power-on/off operation.

The infrared sensor matrix 18 detects a touched position on the touch panel 19 by an infrared sensor, and inputs the detected position to the CPU 14.

The touch panel 19 is attached to the front surface of the image display 4. When the user touches (pushes) an icon displayed on the image display 4, the touched position is detected by the infrared sensor matrix 18.

In the car navigation device 1 having this arrangement, a signal received by the GPS antenna 5 is processed by the GPS receiver 11, synthesized with map data read out from the CD-ROM 13 under the control of the CPU 14, and displayed as current position information on the image display 4 via the map data processor 16. If the vehicle 10 moves, the CPU 14 sequentially reads out corresponding map data from the CD-ROM 13 in accordance with current position information output from the GPS receiver 11, and displays the map data on the image display 4. The car navigation map displayed on the image display 4 is enlarged/reduced by the manipulation button 17.

When the membership card 31 is inserted, the membership card information reader 20 of the car navigation device 1 reads a PIN code recorded on the membership card 31, and outputs the PIN code to the radio communication apparatus 2.

The radio communication apparatus 2 is constituted by a demultiplexer 21 for demultiplexing transmission and reception radio waves, a low-noise amplifier (LNA) 22, a demodulator (DEM) 23, a baseband processor 24 including an authentication processor, an audio processor 25 for processing audio data and driving a loudspeaker 30, a modulator (MOD) 26, a power amplifier 27, and an image data processor 28.

In the radio communication apparatus 2, a signal from the contents stand 41 that is received by the Bluetooth antenna 3 is demultiplexed and extracted by the demultiplexer 21, and amplified by the low-noise amplifier 22. The signal amplified by the low-noise amplifier 22 is demodulated by the demodulator 23 coping with the modulation system of the modulator 26, and sent to the baseband processor 24. The baseband processor 24 operates under the control of the CPU 14 of the car navigation device 1, executes authentication procedures based on a PIN code read out from the membership card 31, and then decodes the received data. Authentication processing will be described later.

If the data decoded by the baseband processor 24 is audio data, the data is output to the loudspeaker 30 via the audio processor 25. If the decoded data is not audio data, i.e., is image data, the data is processed by the image data processor 28, and output to the image display 4.

When the radio communication apparatus 2 transmits data, transmission data generated by the baseband processor 24 is modulated by the modulator 26, and amplified in power by the power amplifier 27, and externally radiated as radio waves from the Bluetooth antenna 3 via the demultiplexer 21.

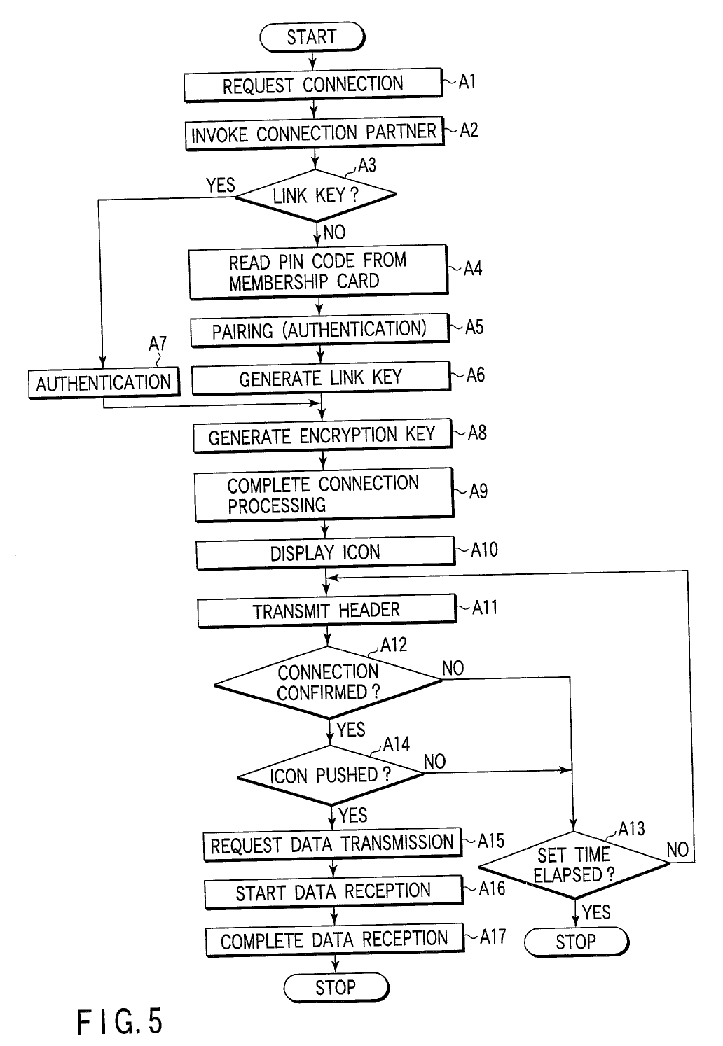

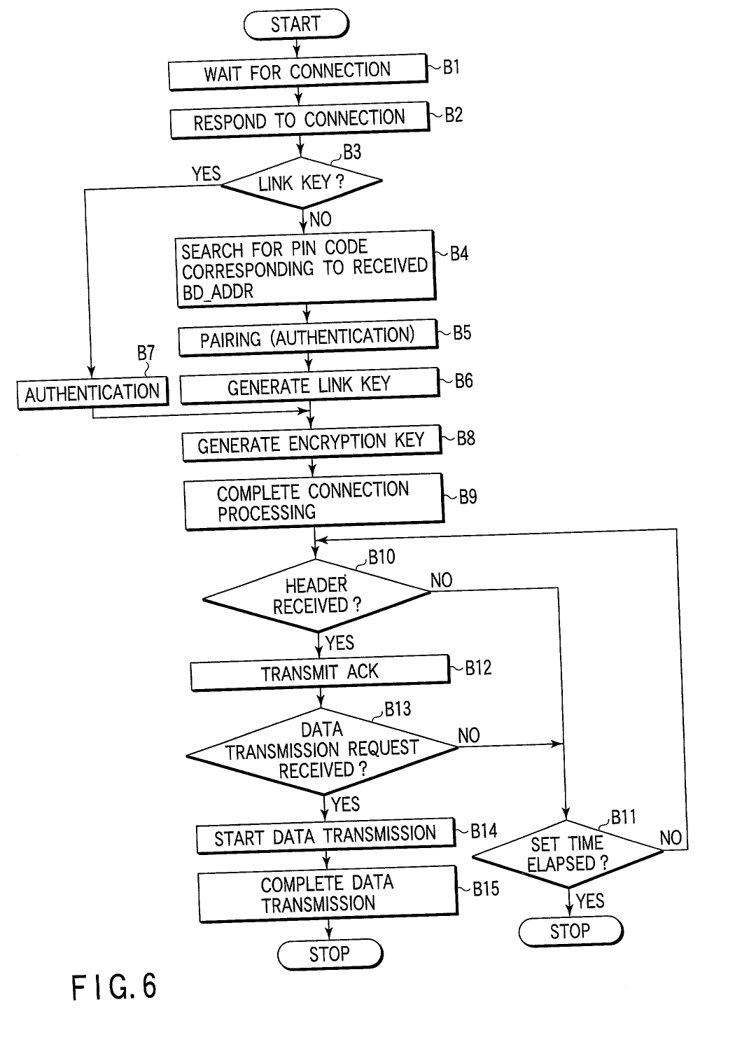

Bluetooth authentication processing and a series of subsequence operations when the car navigation device 1 invokes and connects the contents stand 41 will be explained with reference to the flow charts of FIGS. 5 and 6. FIG. 5 is a flow chart showing processing on the car navigation device 1 side serving as a master device, and FIG. 6 is a flow chart showing processing on the contents stand 41 side serving as a slave device.

Processing on the car navigation device 1 side will be described with reference to FIG. 5.

If the contents stand 41 is to be invoked from the car navigation device 1, the membership card 31 is inserted into the membership card information reader 20 of the car navigation device 1. When the membership card 31 is inserted, the membership card information reader 20 reads the recorded information, and inputs the PIN code to the baseband processor 24 of the radio communication apparatus 2.

If the recorded information of the membership card 31 is read by the membership card information reader 20, or a communication mode with the contents stand 41 is set, the CPU 14 of the car navigation device 1 operates in accordance with a communication program, and controls the baseband processor 24 of the radio communication apparatus 2.

When the vehicle 10 enters the communication area of the contents stand 41 in this state, and radio waves from the contents stand 41 are received by the radio communication apparatus 2, the baseband processor 24 sends a connection request to the contents stand 41 serving as a slave device (step A1), and starts connection processing. In this case, when the membership card 31 is inserted into the membership card information reader 20 while the vehicle 10 is in the communication area of the contents stand 41, connection processing immediately starts.

A 48-bit unique address (BD_ADDR) of a Bluetooth device is designated for the contents stand 41 serving as a connection partner to invoke the contents stand 41 (step A2).

Upon invoking the contents stand 41, the contents stand 41 serving as a connection partner corresponding to the unique address performs response operation. The in-car information processing device 1 determines the presence/absence of a link key corresponding to the contents stand 41 which responded based on the unique address (step A3). If no link key exists (NO in step A3), a PIN (Personal Identification Number) code is read out from the membership card 31 (step A4). No link key exists when the car navigation device 1 is connected to an electronic device having a Bluetooth function for the first time, or a link key was generated in previous connection but was lost.

If NO in step A3, a provisional link key is generated from a 128-bit random number (RAND) and a 1- to 16-byte PIN code read from the membership card 31. Then, pairing for authenticating a connection partner is executed (step A5).

A link key is generated and saved using as parameters the 48-bit unique address (BD_ADDR), the 128-bit random number (RAND), and the provisional link key generated by pairing (step A6).

If YES in step A3, the connection partner is authenticated using as parameters the 48-bit unique address (BD_ADDR), the 128-bit random number (RAND), and a previously generated link key (step A7).

If processing in step A6 or A7 ends, an “encryption key” used for encryption is generated using the 128-bit random number (RAND) and link key as parameters (step A8).

The radio communication apparatus 2 on the car navigation device 1 side serving as a master device for managing connection transmits a master clock for determining the timing and hopping of the radio unit 42 of the Bluetooth unit to the contents stand 41 serving as a slave device, and instructs the contents stand 41 to perform communication synchronized with the master clock.

By this processing, connection processing (setup) is completed (step A9), and data encrypted by the “encryption key” can be communicated.

Upon completion of connection processing, the baseband processor 24 notifies the CPU 14 of the car navigation device 1 of information representing the contents stand 41 as a connection partner together with the connection completion notification. After the CPU 14 receives the connection completion notification, it operates the icon creator 15 to create an icon corresponding to the contents stand 41 serving as a connection partner, and displays the icon on the image display 4 (step A10).

Upon completion of connection processing, the car navigation device 1 instructs the contents stand 41 serving as a slave to remain for a predetermined time in a state in which the contents stand 41 starts data communication corresponding to contents when the icon is pushed once.

After the CPU 14 displays the icon on the image display 4, it stands by for a predetermined time until the icon is pushed. Meanwhile, the CPU 14 confirms the connection state with the contents stand 41.

More specifically, the CPU 14 transmits a header from the radio communication apparatus 2 to the contents stand 41 (step A11), and confirms the connection state from the response signal (step A12). If the CPU 14 does not receive any response from the contents stand 41, the CPU 14 checks whether a predetermined time, e.g., 60 sec has elapsed after the icon is displayed (step A13). If NO in step A13, the CPU 14 returns to step A11 to transmit a header again.

If YES in step A13, the CPU 14 determines whether the icon displayed on the image display 4 was pushed (step A14). If NO in step A14, the CPU 14 shifts to step A13 to check whether a period of 60 sec has elapsed. If the CPU 14 does not receive any response from the contents stand 41 during 60 sec in step A13, or the icon on the display is not pushed, communication stops.

If YES in step A14, the CPU 14 requests data transmission of the contents stand 41 (step A15), and starts reception of data transmitted from the contents stand 41 (step A16). Upon completion of data reception (step A17), the CPU 14 stops communication with the contents stand 41.

Note that if the user wants to stop communication during data reception, he/she pushes the icon displayed on the image display 4 again. Then, the CPU 14 stops communication with the contents stand 41.

Processing of the contents stand 41 serving as a slave device will be explained with reference to the flow chart of FIG. 6.

The contents stand 41 waits for a connection request from the car navigation device 1 serving as a master device (step B1). The contents stand 41 responds to a connection request by the 48-bit unique address (BD_ADDR) of a Bluetooth device that is sent from the radio communication apparatus 2 of the car navigation device 1 (step B2), and determines the presence/absence of a link key (step B3).

If no link key exists (NO in step B3), the contents stand 41 refers to a database saved as a server for the 48-bit unique address (BD_ADDR) sent from the car navigation device 1, and picks up a corresponding PIN code (step B4). In this case, the picked PIN code coincides with a PIN code read from the membership card 31 in the car navigation device 1. Similar to the car navigation device 1, no link key exists when the contents stand 41 is connected to an electronic device having a Bluetooth function for the first time, or a link key was generated in previous connection but was lost.

After that, the contents stand 41 shifts to authentication processing by pairing using the PIN code. That is, the contents stand 41 executes pairing for generating a provisional link key from a 1- to 16-byte PIN code that is saved in the server and corresponds to a 128-bit random number (RAND) and the 48-bit unique address (BD_ADDR) sent from the car navigation device 1, and authenticating a connection partner (step B5).

The contents stand 41 generates a link key using as parameters the 48-bit unique address (BD_ADDR), the 128-bit random number (RAND), and the provisional link key generated by pairing (step B6).

If YES in step B3, the contents stand 41 authenticates a connection partner using the 48-bit unique address (BD-ADDR), 128-bit random number (RAND), and previously generated link key as parameters (step B7).

If processing in step B6 or B7 ends, an “encryption key” used for encryption is generated using the 128-bit random number (RAND) and link key as parameters (step B8).

The contents stand 41 receives a master clock for determining the timing and hopping of the radio unit 42 that is transmitted from the car navigation device 1 serving as a master device, and performs communication synchronized with the master clock.

By this processing, connection processing (setup) is completed (step B9), and contents data encrypted by the “encryption key” can be transmitted.

After connection processing ends, the contents stand 41 receives from the car navigation device 1 an instruction “remain for a predetermined time in a state in which the contents stand 41 starts data communication corresponding to contents when the icon is pushed once.”. The contents stand 41 stands by for a predetermined time upon reception of the instruction. Meanwhile, the contents stand 41 confirms the connection state with the car navigation device 1.

More specifically, the contents stand 41 checks whether the contents stand 41 has received a header sent from the radio communication apparatus 2 of the car navigation device 1 (step B10). If NO in step B10, the contents stand 41 checks whether a predetermined time, e.g., 60 sec has elapsed after completion of connection (step B11). If NO in step B11, the contents stand 41 returns to step B10 to wait for reception of a header.

If YES in step B11, the contents stand 41 executes response processing, and transmits ACK to the car navigation device 1 (step B12). The contents stand 41 determines whether the contents stand 41 has received a data reception request sent from the car navigation device 1 when the icon was pushed once (step B13). If NO in step B13, the contents stand 41 advances to step B11 to checks whether a period of 60 sec has elapsed. If the contents stand 41 does not receive any header from the car navigation device 1 during 60 sec or any data transmission request, the contents stand 41 stops communication.

If YES in step B13, the contents stand 41 starts data transmission to the car navigation device 1 (step B14). If exchange of charge information is necessary after contents data communication, the contents stand 41 exchanges charge information (step B15), and ends the communication program.

According to this embodiment, if the car navigation device 1 and the contents stand 41 outside the vehicle have a short distance and can communicate data, the membership card 31 is inserted into the membership card information reader 20 of the car navigation device 1 to automatically perform authentication processing, thereby displaying an icon corresponding to the contents stand 41. The driver of the vehicle can identify the service contents of the contents stand 41 from the icon displayed on the image display 4. The driver pushes the icon displayed on the image display 4 with his/her finger to execute data communication. At the same time as the completion of communication, the communication program ends. If the driver wants to end processing during data communication, he/she can push the icon displayed on the image display 4 again to end communication processing.

Since the driver of the vehicle can instruct communication with the contents stand 41 by pushing the icon displayed on the image display 4 once, safety driving can be ensured, and the operability can be greatly improved.

In this embodiment, Bluetooth is used as a radio communication means. The present invention, however, can use another short-distance radio communication means.

In the above embodiment, the present invention is applied to the car navigation device 1. Even another electronic device such as a personal computer can be equipped with the membership card information reader 20 and radio communication apparatus 2 to easily communicate with the contents stand 41, similar to the above embodiment.

In the above embodiment, data communication is executed by pushing an icon displayed on the front surface of the image display 4. For example, when the present invention is applied to a personal computer, data communication may be executed by operation such as mouse click.

As has been described above, according to the present invention, authentication information is stored in advance in a membership card corresponding to the services of a contents stand, a membership card information reader is arranged in an electronic device having a radio communication function, and the authentication information of the membership card inserted into the membership card information reader is read to automatically perform authentication processing with the contents stand. The user needs not manually input authentication information through a keyboard or the like, which can simplify communication manipulation.

After authentication processing ends, an icon corresponding to the contents stand is displayed on the screen of the electronic device, and communication processing is executed by pushing the icon once. With very simple manipulation, the user can instruct execution of communication processing. By applying the present invention to an in-car device such as a car navigation device, safety driving can be ensured, and the operability can be greatly improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio data communication apparatus configured to perform radio data communication with a contents stand which provides a service of contents, the radio data communication apparatus comprising:
a membership card information reader configured to read authentication information recorded in advance from a membership card which is to be used for an authentication between the radio data communication apparatus and the contents stand;
authentication means for executing authentication processing with the contents stand by use of the authentication information;
means for making the authentication means to start an execution of the authentication processing by supplying the authentication information read by the membership card information reader to the authentication means; and
data communication means for executing radio data communication with the contents stand after authentication processing by said authentication means ends.

2. A radio data communication apparatus according to claim 1, wherein said membership card comprises an IC card storing said authentication information electrically.

3. A radio data communication apparatus according to claim 1, wherein said membership card comprises an card on which a magnetic portion is pasted, the portion storing said authentication information magnetically.

4. A radio data communication apparatus according to claim 1, wherein said authentication information includes PIN (Personal Identification Number) code corresponding to the service of contents issued by said contents stand.

5. A radio data communication apparatus according to claim 1, further comprising:
a display; and
icon display means for displaying a data communication start icon on the display after authentication processing by said authentication means ends,
wherein said data communication means starts, upon operating the icon, said radio data communication with the contents stand.

6. A radio data communication apparatus according to claim 2, further comprising a touch panel mounted on a front surface of said display,
wherein said touch panel detects push operation on said icon to start said radio data communication.

7. A radio data communication apparatus according to claim 1, wherein said display is incorporated in an car navigation device which displays car navigation information.

8. A vehicle comprising:
a car navigation device which receives car navigation information from outside and provides the information on a display;
a radio data communication apparatus, connected to the car navigation device, configured to perform radio data communication with a contents stand which provides a service of contents, the radio data communication apparatus comprising:
a membership card information reader configured to read authentication information recorded in advance from a membership card which is to be used for an authentication between the radio data communication apparatus and the contents stand;
authentication means for executing authentication processing with the contents stand by use of the authentication information;
means for making the authentication means to start an execution of the authentication processing by supplying the authentication information read by the membership card information reader to the authentication means;
data communication means for executing radio data communication with the contents stand after authentication processing by said authentication means ends; and
display control means for controlling the display so as to display said car navigation information and image information contained in the contents served from said contents stand.

9. A vehicle according to claim 8, further comprising:
audio processing means for outputting audio information contained in said contents served from said contents stand to a speaker.

10. A vehicle according to claim 8, wherein said membership card comprises an IC card storing said authentication information electrically.

11. A vehicle according to claim 8, wherein said membership card comprises an card on which a magnetic portion is pasted, the portion storing said authentication information magnetically.

12. A vehicle according to claim 8, wherein said authentication information includes PIN (Personal Identification Number) code corresponding to the service of contents issued by said contents stand.

13. A vehicle according to claim 8, further comprising:
icon display means for displaying a data communication start icon on the display after authentication processing by said authentication means ends,
wherein said data communication means starts, upon operating the icon, said radio data communication with the contents stand.

14. A vehicle according to claim 13, further comprising a touch panel mounted on a front surface of said display,
wherein said touch panel detects push operation on said icon to start said radio data communication.

15. A radio communication method of communicating with a contents stand which provides a service of contents, the method comprising the steps of:
awaiting an insertion of a membership card into a card reader, the membership card containing an authentication information which is recorded in advance;
reading the authentication information from the membership card by the reader;
invoking an opponent of a radio communication provided in the contents stand;
sending the read authentication information to the opponent via the radio communication;
receiving a confirmation of connection based on the authentication information from the opponent; and
starting an authenticated radio communication using the confirmation of connection, the communication including a reception of the contents served from the contents stand.
